(19) United States
(12) Patent Application Publication
(10) Pub. No.: US 2015/0281835 A1
(43) Pub. Date: Oct. 1, 2015

(54) VOICE COIL

(71) Applicant: CHENG UEI PRECISION INDUSTRY CO., LTD., New Taipei City (TW)

(72) Inventors: Jiin Tarng Huang, New Taipei City (TW); Mu Tsun Tseng, New Taipei City (TW)

(73) Assignee: CHENG UEI PRECISION INDUSTRY CO., LTD., New Taipei City (TW)

(21) Appl. No.: 14/226,011

(22) Filed: Mar. 26, 2014

(51) Int. Cl. H04R 3/00

(52) U.S. Cl. CPC H04R 3/00

(57) ABSTRACT

A voice coil adapted for an electricity-powered loudspeaker includes a plurality of coils formed by winding an enameled wire. The coils are stacked up and down to show a hollow multilayer structure with an accommodating space being formed therein. Each coil has two parallel and spaced straight-line segments, and two symmetrical arc segments oppositely connected between the two straight-line segments. A middle of the arc segment is arched outward. The center of each arc segment is located at another arc segment and the radius of each arc segment is greater than a spacing distance between the two straight-line segments to realize a biaxial voice coil.

### BACKGROUND OF THE INVENTION

1. Field of the Invention

The present invention generally relates to a voice coil, and more particularly to a voice coil applied in an electricity-powered loudspeaker.

2. The Related Art

In general, a voice coil is adapted for an electricity-powered loudspeaker which includes a magnetic circuit system, a voice coil and a vibrating diaphragm. One end of the voice coil is connected with the vibrating diaphragm. The voice coil is an important drive element of the electricity-powered loudspeaker and is located in the magnetic circuit system. The magnetic circuit system includes a magnet. There is a magnetic field with a certain magnetic density in the magnetic circuit system. When an electric current is passed through the voice coil, the voice coil will proceed an alternating motion by virtue of an acting force exerted on the voice coil by the magnetic field to bring along the vibrating diaphragm to vibrate so as to push the air around the vibrating diaphragm to move back and forth for emitting sound waves.

The acting force exerted on the voice coil by the magnetic field is equal to the product of a magnetic density, a length of the voice coil and the electric current. A calculation expression of the acting force exerted on the voice coil by the magnetic field can be expressed as follows: F=B*L*I, wherein F indicates the acting force exerted on the voice coil by the magnetic field, B indicates the magnetic density, L indicates the length of the voice coil, and I indicates the electric current. Conventionally, the voice coil applied in the electricity-powered loudspeaker is assembled to a mobile phone or other electronic device, and the voice coil applied in the electricity-powered loudspeaker shows a rectangular shape or a racetrack shape.

Referring to FIG. 1, it shows a conventional racetrack-shaped voice coil 1′ which is formed by winding a first enameled wire 11′. The racetrack-shaped voice coil 1′ includes a plurality of first coils 10′ stacked up and down to show a hollow multilayer structure with a first accommodating space 12′ being formed therein for accommodating the magnet. Each first coil 10′ of the racetrack-shaped voice coil 1′ includes two straight-line segments 13′, and two arc segments 14′ oppositely connected between the two straight-line segments 13′. A middle of each arc segment 14′ is arched outward. A spacing distance between the two middles of the two arc segments 14′ of the first coil 10′ of the racetrack-shaped voice coil 1′ is 10 mm, and a spacing distance between the two straight-line segments 13′ of the first coil 10′ of the racetrack-shaped voice coil 1′ is 5 mm. The radius of the arc segment 14′ is 2.5 mm. The circumference of the first coil 10′ of the racetrack-shaped voice coil 1′ is 25.7 mm. The radius of each arc segment 14′ is equal to one half of the spacing distance between the two straight-line segments 13′.

Referring to FIG. 2, it shows a conventional rectangular voice coil 2′ which is formed by winding a second enameled wire 21′. The rectangular voice coil 2′ includes a plurality of second coils 20′ stacked up and down to show another hollow multilayer structure with a second accommodating space 22′ being formed therein for accommodating the magnet. Each second coil 20′ of the rectangular voice coil 2′ includes two long segments 23′, and two short segments 24′ respectively connected with the two long segments 23′. The length of the long segment 23′ is 10 mm, and the length of the short segment 24′ is 5 mm. The circumference of the second coil 20′ of the rectangular voice coil 2′ is 30 mm.

Referring to FIG. 1 and FIG. 2, from the description above, it can be known that in the condition of a specification of the first enameled wire 11′ being the same as a specification of the second enameled wire 21′, a stacking height of the first coils 10′ of the racetrack-shaped voice coil 1′ being the same as a stacking height of the second coils 20′ of the rectangular voice coil 2′, the spacing distance between the two middles of the two arc segments 14′ being the same as the length of the long segment 23′, and the spacing distance between the two straight-line segments 13′ being the same as the length of the short segment 24′, the circumference of the second coil 20′ of the rectangular voice coil 2′ is longer than the circumference of the first coil 10′ of the racetrack-shaped voice coil 1′. So the second enameled wire 21′ is longer than the first enameled wire 11′, and the second accommodating space 22′ is larger than the first accommodating space 12′ to make an area of the magnet accommodated in the second accommodating space 22′ be larger than an area of the magnet accommodated in the first accommodating space 12′. Accordingly, an efficiency of the rectangular voice coil 2′ is more than an efficiency of the racetrack-shaped voice coil 1′.

However, when the rectangular voice coil 2′ bears high power, a structure stability of the rectangular voice coil 2′ is worse to make the rectangular voice coil 2′ apt to deform so that affects a quality of the electricity-powered loudspeaker.

Thus, it is essential to provide a voice coil with a more stable structure and a higher efficiency for satisfying different needs of the electricity-powered loudspeaker.

### SUMMARY OF THE INVENTION

An object of the present invention is to provide a voice coil adapted for being applied in an electricity-powered loudspeaker. The voice coil includes a plurality of coils formed by winding an enameled wire. The coils are stacked up and down to show a hollow multilayer structure with an accommodating space being formed therein. Each coil has two parallel and spaced straight-line segments, and two symmetrical arc segments oppositely connected between the two straight-line segments. A middle of the arc segment is arched outward. The center of each arc segment is located at another arc segment and the radius of each arc segment is greater than a spacing distance between the two straight-line segments to realize a biaxial voice coil.

As described above, when the voice coil in accordance with the present invention bears high power, a structure stability of the voice coil is better to make the voice coil never deform so that ensures a quality of the electricity-powered loudspeaker. Thus, the voice coil has the more stable structure and the higher efficiency to satisfy different needs of the electricity-powered loudspeaker.

### BRIEF DESCRIPTION OF THE DRAWINGS

The present invention will be apparent to those skilled in the art by reading the following description, with reference to the attached drawings, in which:

FIG. 1 is a vertical view of a racetrack-shaped voice coil in the prior art;

FIG. 2 is a vertical view of a rectangular voice coil in the prior art;

FIG. 3 is a perspective view of a voice coil in accordance with a first embodiment of the present invention;

FIG. 4 is a vertical view of the voice coil of FIG. 3; and

FIG. 5 is a vertical view of a voice coil in accordance with a second embodiment of the present invention.

### DETAILED DESCRIPTION OF THE PREFERRED EMBODIMENT

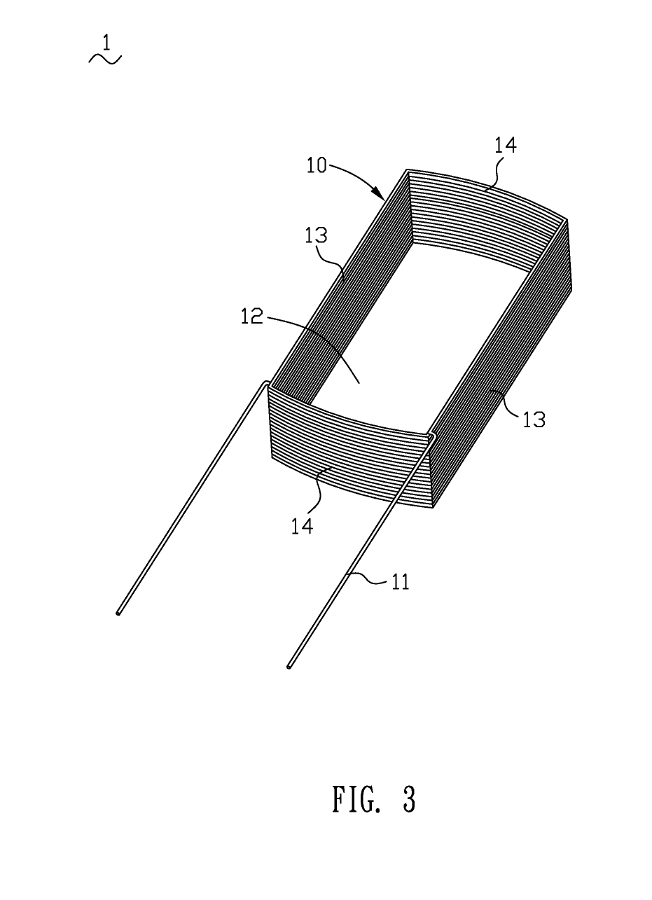

With reference to FIG. 3 to FIG. 5, a voice coil 1 in accordance with the present invention is shown. The voice coil 1 is adapted for being applied in an electricity-powered loudspeaker (not shown). The voice coil 1 includes a plurality of coils 10 formed by winding an enameled wire 11. The coils 10 of the voice coil 1 are stacked up and down to show a hollow multilayer structure with an accommodating space 12 being formed therein for accommodating a magnet (not shown).

With reference to FIG. 3 to FIG. 5 again, each coil 10 of the voice coil 1 has two parallel and spaced straight-line segments 13, and two symmetrical arc segments 14 oppositely connected between the two straight-line segments 13. A middle of the arc segment 14 is arched outward. Peripheries of the coils 10 of the voice coil 1 are arranged at regular intervals and are parallel and flush. The center of each arc segment 14 is located at another arc segment 14 and the radius of each arc segment 14 is greater than a spacing distance between the two straight-line segments 13, so that the coil 10 and the voice coil 1 are biaxial.

Specifically, lengths of the two straight-line segments 13 are equal to each other and radiuses of the two arc segments 14 are equal to each other. In detail, a spacing distance between the two middles of the two arc segments 14 of the coil 10 of the voice coil 1 is 10 mm, and the spacing distance between the two straight-line segments 13 of the coil 10 of the voice coil 1 is 5 mm. The length of the straight-line segment 13 of the coil 10 of the voice coil 1 is 9.36 mm. The radius of the arc segment 14 of the coil 10 of the voice coil 1 is 10 mm. The circumference of the coil 10 of the voice coil 1 is 28.82 mm.

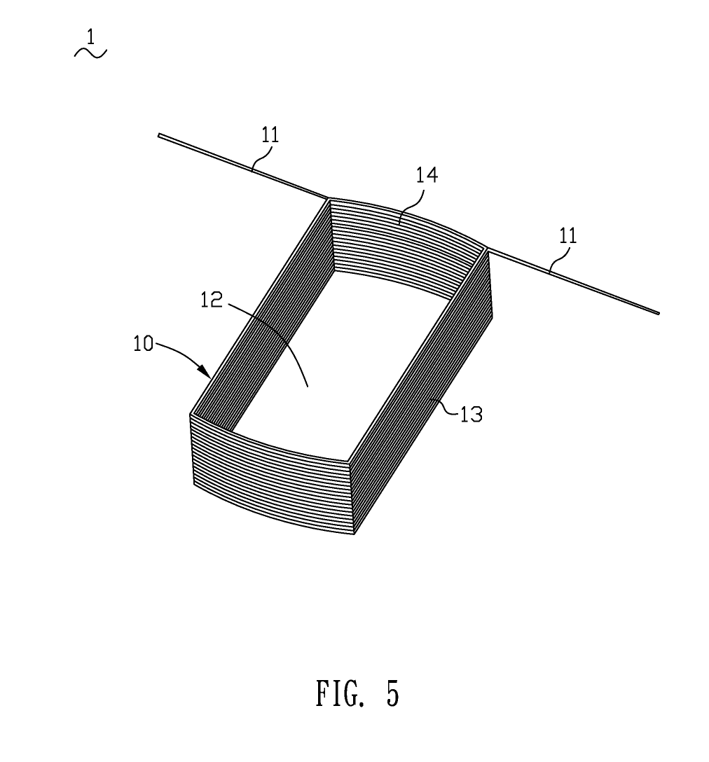

Referring to FIG. 3 and FIG. 5, the two free ends of the enameled wire 11 of the voice coil 1 can be drawn forth at a 180-degree angle with respect to the straight-line segments 13 respectively, or at a 90-degree angle with respect to the straight-line segments 13 respectively.

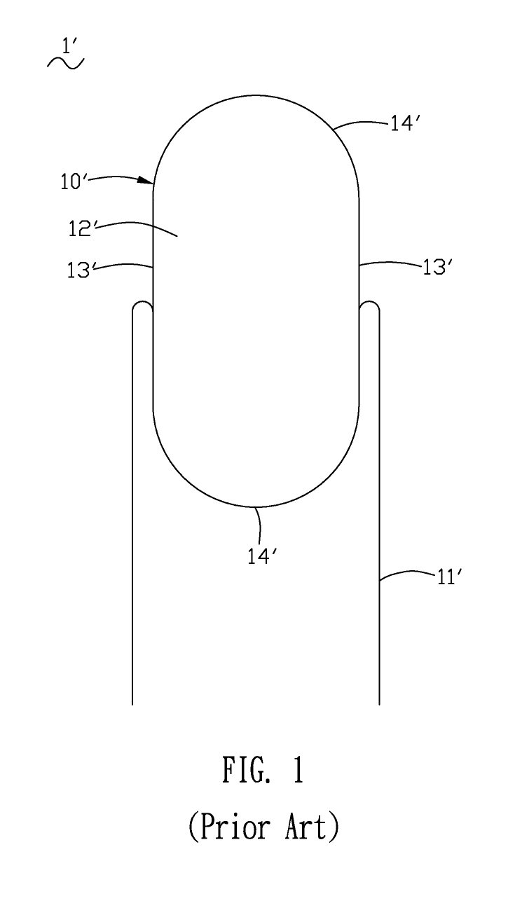

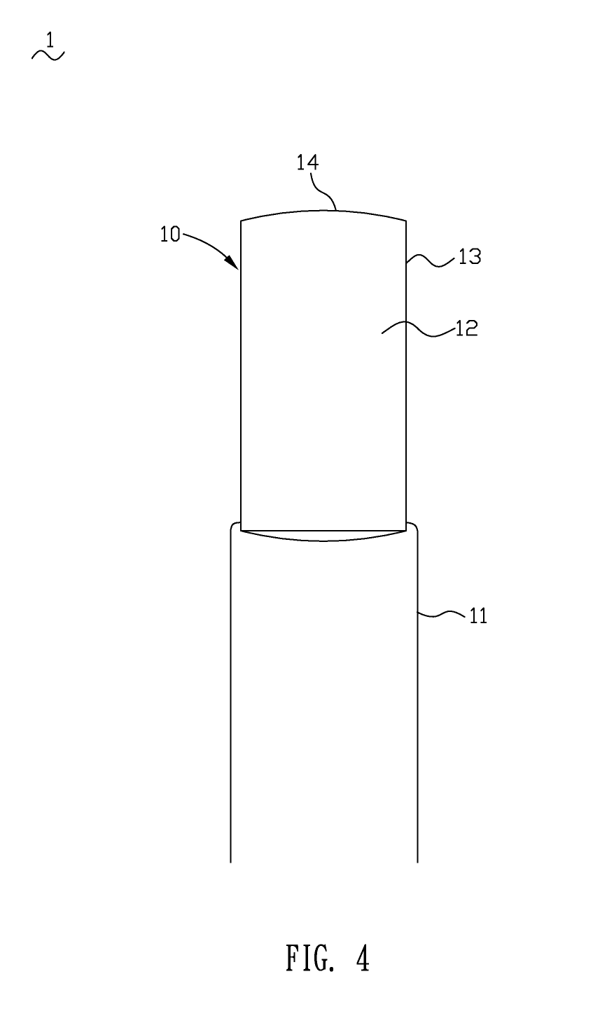

Referring to FIG. 1, FIG. 3, FIG. 4 and FIG. 5, comparing with the racetrack-shaped voice coil 1′ in the prior art, in the condition of a specification of the enameled wire 11 of the voice coil 1 being the same as the specification of the first enameled wire 11′ of the racetrack-shaped voice coil 1′, a stacking height of the coils 10 of the voice coil 1 being the same as the stacking height of the first coils 10′ of the racetrack-shaped voice coil 1′, the spacing distance between the two middles of the two arc segments 14 of the coil 10 of the voice coil 1 being the same as the spacing distance between the two middles of the two arc segments 14′ of the first coil 10′ of the racetrack-shaped voice coil 1′, and the spacing distance between the two straight-line segments 13 of the coil 10 of the voice coil 1 being the same as the spacing distance between the two straight-line segments 13′ of the first coil 10′ of the racetrack-shaped voice coil 1′, the circumference of the coil 10 of the voice coil 1 in accordance with the present invention is greater than the circumference of the first coil 10′ of the racetrack-shaped voice coil 1′ of FIG. 1. So the enameled wire 11 of the voice coil 1 is longer than the first enameled wire 11′ of the racetrack-shaped voice coil 1′, and the accommodating space 12 of the voice coil 1 is larger than the first accommodating space 12′ of the racetrack-shaped voice coil 1′ to make an area of the magnet accommodated in the accommodating space 12 be larger than the area of the magnet accommodated in the first accommodating space 12′. Accordingly, an efficiency of the voice coil 1 is more than an efficiency of the racetrack-shaped voice coil 1′.

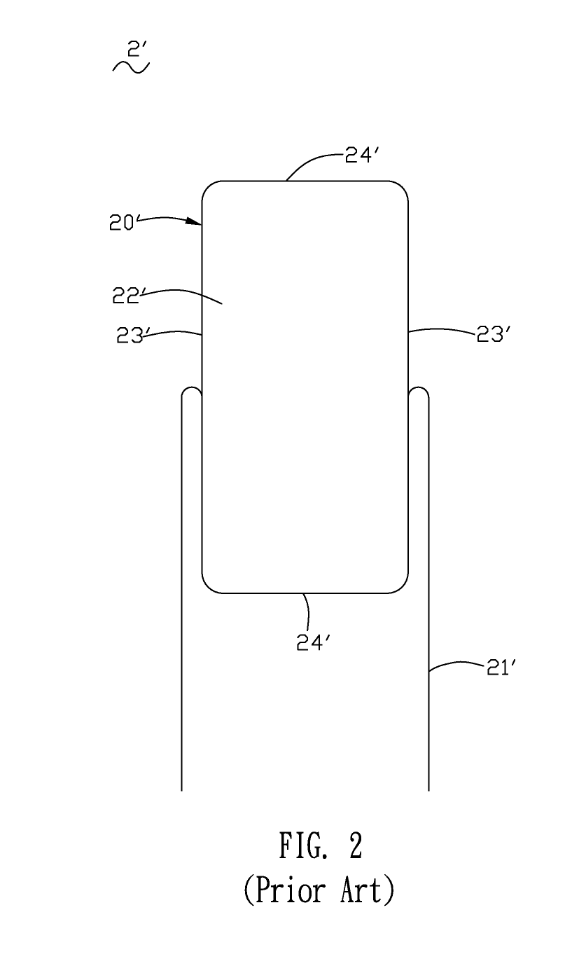

Referring to FIGS. 2-5, comparing with the rectangular voice coil 2′ in the prior art, in the condition of the specification of the enameled wire 11 of the voice coil 1 being the same as the specification of the second enameled wire 21′ of the rectangular voice coil 2′, the stacking height of the coils 10 of the voice coil 1 being the same as the stacking height of the second coils 20′ of the rectangular voice coil 2′, the spacing distance between the two middles of the two arc segments 14 of the coil 10 of the voice coil 1 being the same as the length of the long segment 23′ and the spacing distance between the two straight-line segments 13 of the coil 10 of the voice coil 1 being the same as the length of the short segment 24′, the circumference of the coil 10 of the voice coil 1 in accordance with the present invention is nearly equal to the circumference of the second coil 20′ of the rectangular voice coil 2′ of FIG. 2. So the length of the enameled wire 11 of the voice coil 1 is nearly equal to the length of the second enameled wire 21′ of the voice coil 2′, and the accommodating space 12 of the voice coil 1 is nearly equal to the second accommodating space 22′ of the rectangular voice coil 2′ to make the area of the magnet accommodated in the accommodating space 12 be nearly equal to the area of the magnet accommodated in the second accommodating space 22′. Accordingly, the efficiency of the voice coil 1 is nearly equal to the efficiency of the rectangular voice coil 2′.

As described above, when the voice coil 1 in accordance with the present invention bears high power, a structure stability of the voice coil 1 is better to make the voice coil 1 never deform so that ensures a quality of the electricity-powered loudspeaker. Thus, the voice coil 1 has the more stable structure and the higher efficiency to satisfy different needs of the electricity-powered loudspeaker.

What is claimed is:

1. A voice coil adapted for an electricity-powered loudspeaker, comprising:
a plurality of coils formed by winding an enameled wire, the coils being stacked up and down to show a hollow multilayer structure with an accommodating space being formed therein, each coil having two parallel and spaced straight-line segments, and two symmetrical arc segments oppositely connected between the two straight-line segments, a middle of the arc segment being arched outward,
wherein the center of each arc segment is located at another arc segment and the radius of each arc segment is greater than a spacing distance between the two straight-line segments to realize a biaxial voice coil.

2. The voice coil as claimed in claim 1, wherein the two free ends of the enameled wire of the voice coil can be drawn forth at a 180-degree angle with respect to the straight-line segments respectively.

3. The voice coil as claimed in claim 1, wherein the two free ends of the enameled wire of the voice coil can be drawn forth at a 90-degree angle with respect to the straight-line segments respectively.

4. The voice coil as claimed in claim 1, wherein lengths of the two straight-line segments are equal to each other.

5. The voice coil as claimed in claim 1, wherein radiuses of the two arc segments are equal to each other.

6. The voice coil as claimed in claim 1, wherein peripheries of the coils are arranged at regular intervals.

7. The voice coil as claimed in claim 6, wherein the peripheries of the coils are parallel and flush.
